(19) United States
(12) Patent Application Publication
(10) Pub. No.: US 2012/0183831 A1
(43) Pub. Date: Jul. 19, 2012

(54) ENERGY STORAGE MODULE AND METHOD FOR MANUFACTURING THE SAME

(75) Inventors: Younghak JEONG, Gyeonggi-do (KR); Baekyung Kim, Gyeonggi-do (KR); Hyunchul Jung, Gyeonggi-do (KR)

(73) Assignee: SAMSUNG ELECTRO-MECHANICS CO., LTD.

(21) Appl. No.: 13/191,077

(22) Filed: Jul. 26, 2011

(30) Foreign Application Priority Data
Jan. 13, 2011 (KR) 10-2011-0003514

(51) Int. Cl. H01M 10/50; H01M 4/82; H01M 10/02

(52) U.S. Cl. 429/120; 429/159; 29/623.5

(57) ABSTRACT

Disclosed herein are an energy storage module formed by interconnecting a plurality of battery units, each of the plurality of battery units being formed by interconnecting two unit batteries and seating the interconnected unit batteries in a reception member, and a method for manufacturing the same. The energy storage module has conductive coating layers included in upper and lower plates contacting electrode tabs in a reception member to interconnect the conductive coating layers through a bus bar during manufacturing of a battery module rather than to interconnect the conductive coating layers by performing a welding method several times, thereby making it possible to more firmly couple the battery module. In addition, it is possible to flexibly form the battery module, as needed, and effectively radiate heat generated within the battery module during actual driving thereof.

### CROSS REFERENCE(S) TO RELATED APPLICATIONS

This application claims the benefit under 35 U.S.C. Section 119 of Korean Patent Application Serial No. 10-2011-0003514, entitled “Energy Storage Module And Method For Manufacturing The Same” filed on Jan. 13, 2011, which is hereby incorporated by reference in its entirety into this application.

### BACKGROUND OF THE INVENTION

1. Technical Field

The present invention relates to an energy storage module and a method for manufacturing the same.

2. Description of the Related Art

A secondary battery, which is a kind of rechargeable energy storage has been recently widely used as an energy source of a wireless mobile device. In addition, the secondary battery has been prominent as a power source of an electric vehicle (EV), a hybrid electric vehicle (HEV), etc., that have been suggested as a scheme for solving air pollution of an existing gasoline vehicle, diesel vehicle, etc., using a fossil fuel.

Small-sized mobile devices use one or more battery cells per one device. In contrast, due to necessity of high output and large capacity, middle and large-sized devices such as a vehicle, etc., use a middle and large-sized battery module in which a plurality of battery cells are electrically interconnected.

This middle and large-sized battery module is generally configured of a plurality of battery cells interconnected in series. The secondary battery is manufactured to have several shapes such as a cylindrical shape or a square shape. Each of the battery cells is configured to include an electrode assembly in which a positive electrode and a negative electrode are positioned, having a separator therebetween, a case including a space having the electrode assembly embedded therein, a cap assembly coupled to the case to close the case, and positive electrode and negative electrode tabs protruding to the cap assembly and electrically connected to current collectors of positive electrode and negative electrode plates included in the electrode assembly.

In the case of each battery cell in the square shaped battery, each unit battery is alternately arranged so that the positive electrode tab and the negative electrode tab, protruding to an upper portion of the cap assembly, are alternated with a positive electrode tab and a negative electrode tab of a neighboring unit battery, and conductor is connected between screw processed negative electrode and positive electrode tabs through a nut, thereby forming a battery module.

Here, several to several tens of battery cells are interconnected, thereby forming a single battery module. Due to increase in volume of the battery module, volume in an external device in which the battery module is used is increased, thereby causing a limitation in design. Particularly, when the secondary battery module is used as a large capacity secondary battery for driving a motor of an electric cleaner, an electric scooter, or a vehicle (an electric vehicle or a hybrid vehicle), an installation space of the battery module is narrow, such that there is a need to minimize the volume of the battery module.

Since a size and a weight of the battery module is directly related to a reception space, an output, and the like, of the corresponding middle and large-sized device, etc., manufacturers have made an effort to manufacture a battery module as small and light as possible.

In addition, since each battery cell generates a large amount of heat therein during an operation thereof, the battery module configured of a plurality of battery cells should be capable of easily radiating the generated heat. Therefore, according to the related art, in order to radiate the heat within the battery module, a method such as a method in which a path through which a refrigerant may be ventilated between each unit battery is installed or each battery cell is maintained at predetermined intervals, etc., has been used. However, there still was a problem in that it is difficult to regularly arrange and interconnect the plurality of battery cells.

In addition, in the case of devices suffering from much impact, vibration, etc., from the outside, such as an electric bicycle, an electric vehicle, etc., since an electrical interconnection state and a physical coupling state between elements configuring the battery module should be stable and high output and large capacity should be implemented using a plurality of batteries, stability has also become important.

Therefore, in order to obtain power having high output and large capacity, there is a considerable need for a technique in which the plurality of battery cells configuring the middle and large-sized battery module are effectively interconnected, thereby making it possible to minimize the volume of the middle and large-sized battery module while maintaining the stability thereof.

### SUMMARY OF THE INVENTION

An object of the present invention is to provide an energy storage module in which a plurality of battery cells are effectively interconnected to thereby improve a heat radiating effect.

Another object of the present invention is to provide a method for manufacturing an energy storage module.

According to an exemplary embodiment of the present invention, there is provided an energy storage module formed by interconnecting a plurality of battery units, each of the plurality of battery units being formed by interconnecting two unit batteries and seating the interconnected unit batteries in a reception member.

The reception member may include an upper plate and a lower plate, and the upper plate and the lower plate may include conductive coating layers formed at parts contacting tabs of the battery unit.

The conductive coating layer may be formed by plating a conductive metal.

The conductive coating layer may be formed by compressing a conductive metal.

The reception member may include baskets for receiving electrode assemblies of the unit batteries therein.

The baskets may be formed to have a height lower than those of cases of each of the unit batteries.

Conductive coating layers formed at parts contacting tabs of the plurality of battery units may be interconnected through a bus bar.

Each of the battery units may include a cooling device.

The cooling device may be included in an upper portion or a lower portion of each of the battery units.

According to another exemplary embodiment of the present invention, there is provided a method for manufacturing an energy storage module, the method including: interconnecting two unit batteries; forming conductive coating layers at contacting parts of an upper plate and a lower plate of a reception member; seating the interconnected unit batteries in the reception member to manufacture a battery unit; interconnecting a plurality of battery units; and interconnecting conductive coating layers formed at parts contacting tabs of the plurality of battery units through a bus bar.

The conductive coating layers may be formed at the parts contacting the tabs of the battery units.

The method may further include attaching a cooling device to the battery unit.

### BRIEF DESCRIPTION OF THE DRAWINGS

FIG. 1 is a view showing a process for manufacturing a battery unit by interconnecting unit batteries according to an exemplary embodiment of the present invention;

FIG. 2 is a view showing a process for manufacturing a battery module according to an exemplary embodiment of the present invention; and

FIG. 3 is a view showing an example of a battery module including a heat radiating plate.

### DESCRIPTION OF THE PREFERRED EMBODIMENTS

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

In addition, a thickness or a size of each layer will be exaggerated for convenience of explanation or clarity and like reference numbers will indicate the same components, in the drawings below. As used in the present specification, a term “and/or” includes any one or at least one combination of enumerated items.

In the present specification, although terms such as a first, a second, etc., are used to explain various members, components, areas, layers and/or portions thereof, these members, components, areas, layers and/or portions thereof are not limited to these terms. These terms are used only to distinguish one member, component, area, layer or a portion thereof from another member, component, area, layer or a portion thereof. Accordingly, a first member, a first component, a first area, a first layer, or a portion thereof described below may indicate a second member, a second component, a second area, a second layer, or a portion thereof.

The present invention relates to an energy storage module formed by interconnecting a plurality of battery cells, and a method for manufacturing the same. The energy storage module according to an exemplary embodiment of the present invention is formed by interconnecting a plurality of battery units in which two unit batteries are interconnected and are seated in a reception member.

Each of the unit batteries has a structure in which an electrode assembly having a positive electrode, a negative electrode, a separator disposed therebetween, is seated in an external case and positive electrode and negative electrode tabs electrically connected to current collectors of the positive electrode and the negative electrode of the electrode assembly are exposed to an outer portion of the external case.

The external case is preferably a pouch shaped polymer case, and the positive electrode, the negative electrode, and the separator configuring each of the unit batteries are not specifically limited. However, the positive electrode and negative electrode tabs are formed in different directions.

Two unit batteries each formed as described above are interconnected, thereby forming a single battery unit. The two unit batteries are preferably interconnected in series. In the case of interconnecting three or more batteries, it is difficult to form the battery module.

The battery unit formed by interconnecting the two unit batteries is seated in the reception member having a shape similar to that of the unit battery. The reception member includes an upper plate and a lower plate, and also includes baskets having a predetermined shape so that each of the unit batteries may be received therein.

The basket is preferably formed to have a height lower than a thickness of each of the unit batteries. This is the reason that the reception member includes the upper plate and the lower plate and pressure is applied to each of the unit batteries when the upper plate and the lower plate are fixed, such that when the basket is formed to have the height lower than the thickness of each of the unit batteries, a space in which each of the unit batteries may be partially compressed is formed.

In addition, the upper plate and the lower plate of the reception member include conductive coating layers formed at both parts contacting the positive electrode and negative electrode tabs of the battery unit. According to an exemplary embodiment of the present invention, the conductive coating layer may be formed by plating a conductive metal. According to another exemplary embodiment of the present invention, the conductive coating layer may be formed by compressing a conductive metal.

Here, the used conductive metal may be at least one selected from a group consisting of Ni, Au, Ag, Cu, Zn, Cr, Al, Co, Sn, Pt and Pd; however, it is not limited thereto.

The conductive coating layer has preferably a thickness of 100 μm or more; however, it has preferably a size corresponding to those of the positive electrode and negative electrode tabs of each electrode.

As described above, the two unit batteries are interconnected and are seated in the reception member, and the upper plate and the lower plate of the reception member are then fixed, thereby completing the battery unit. The upper plate and the lower plate of the reception member may be fixed by a heat fusing method; however, a method of fixing the upper plate and the lower plate of the reception member is not specifically limited thereto.

A plurality of completed battery units are interconnected, thereby making it possible to form an energy storage module. The completed battery units may be interconnected in series or in parallel according to the usage thereof.

The plurality of battery units are disposed in series or in parallel while being spaced by a predetermined interval therebetween, and the conductive coating layers formed at parts contacting the tabs of the battery unit are then interconnected through a bus bar.

When the tabs of each of the battery units are interconnected through the bus bar, they may be interconnected in a zig-zag shape. That is, since the tabs of each of the battery units are formed at both sides, a first battery unit and a second battery unit are interconnected through a single bus bar at one side, and the second battery unit and a third battery unit are interconnected through a single bus bar at the other side.

In addition, each of the battery units may include a cooling device formed on an upper portion or a lower portion thereof. The cooling device is to effectively radiate heat generated in the battery. Each of the battery units may further include a heat radiating plate such as a heat sink having high thermal conductivity. A plurality of heat radiating plates may be attached to the upper and lower portions of each of the battery units.

Hereinafter, a method for manufacturing an energy storage module according to an exemplary embodiment of the present invention will be described. A method for manufacturing an energy storage module according to an exemplary embodiment of the present invention may include interconnecting the two unit batteries, forming the conductive coating layers at contacting parts of the upper plate and the lower plate of the reception member, seating the interconnected unit batteries in the reception member to manufacture the battery unit, interconnecting a plurality of battery units, and interconnecting the conductive coating layers formed at parts contacting tabs of the plurality of battery units through the bus bar.

The conductive coating layer may be formed at the part contacting the tab of the battery unit.

The method for manufacturing an energy storage module according to an exemplary embodiment of the present invention may further include attaching the cooling device to the battery unit.

In the energy storage module according to an exemplary embodiment of the present invention, the two unit batteries form the unit, thereby making it possible to flexibly design a battery module and a middle and large-sized battery pack. In addition, the battery module and pack that are weak against vibration may be firmly designed by making a mechanical bus bar interconnection rather than making an interconnection by performing a welding method several times according to the related art.

Hereinafter, a process for manufacturing an energy storage module according to an exemplary embodiment of the present invention will be described in detail in order to assist in the understanding of the present invention. Examples of the present invention are provided in order to more completely explain the present invention to those skilled in the art. Examples below may be modified in several different forms and does not limit a scope of the present invention. Rather, these Examples are provided in order to make this disclosure more thorough and complete and completely transfer ideas of the present invention to those skilled in the art.

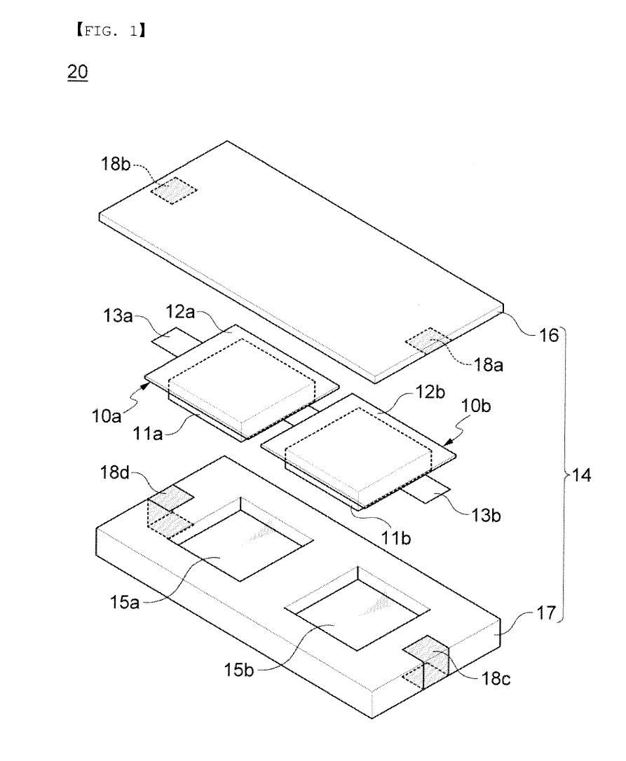

FIG. 1 shows a process for manufacturing a battery cell according to an exemplary embodiment of the present invention. A process for manufacturing a battery cell according to an exemplary embodiment of the present invention will be described in detail with reference to FIG. 1.

First, two battery cells 10a and 10b are interconnected in series. Each of the battery cells 10a and 10b is formed in a state in which electrode assemblies 11a and 11b including a positive electrode, a separator, and a negative electrode are packaged by pouch-shaped cases 12a and 12b. In addition, each of the positive electrode and negative electrode tabs 13a and 13b extended from current collectors of each electrode are exposed to the outside of the pouch-shaped cases 12a and 12b.

In addition, the battery cells interconnected in series are inserted into the reception member 14 having a shape similar to that of the battery cell. The reception member 14 includes the baskets 15a and 15b for seating each of the battery cells 10a and 10b therein. Further, the reception member 14 is constituted of the upper plate 16 and the lower plate 17 having the baskets 15a and 15b embedded therein.

The baskets 15a and 15b are preferably formed to have a height lower than those of each of the battery cells 10a and 10b to thereby flexibly cope with pressure applied to each of the battery cells 10a and 10b when the upper plate 16 and the lower plate 17 of the reception member 14 are heat bonded.

In addition, the conductive coating layers 18a, 18b, 18c, and 18d are preferably formed at parts of the upper plate 16 and the lower plate 17 of the reception member 14 to which each of the electrode tabs contacts. The conductive coating layers 18a, 18b, 18c, and 18d may be formed by plating or compressing the conductive metal. The conductive coating layer has a size corresponding to those of each of the electrode tabs and a thickness of 100 μm or more.

Then, the interconnected battery cells are seated in the reception member 14, and the upper plate 16 and the lower plate 17 are heat bonded and fixed, thereby manufacturing a single battery unit 20. In this case, the conductive coating layers 18a and 18c each formed on the upper plate 16 and the lower plate 17 of the reception member 14 contact each other, and the conductive coating layers 18b and 18d each formed on the upper plate 16 and the lower plate 17 of the reception member 14 contact each other.

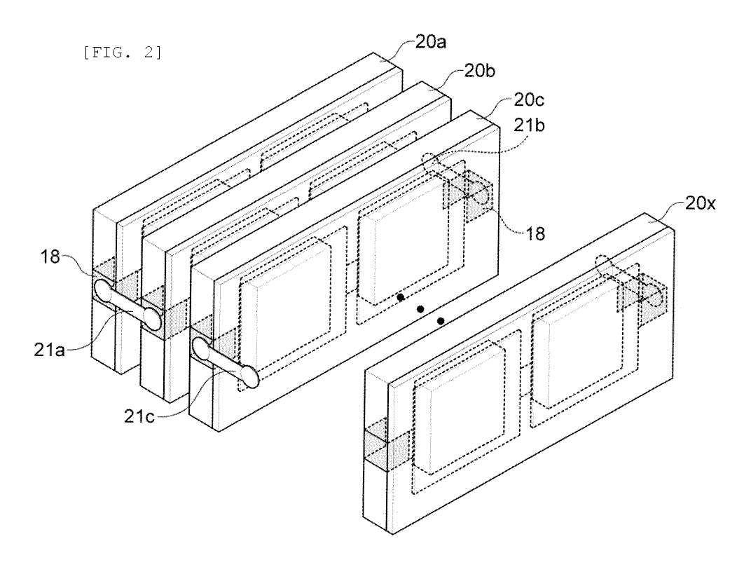

Then, as shown in FIG. 2, the plurality of battery units 20 are interconnected, thereby making it possible to form the module. First, each of the completed battery units 20a, 20b, and 20c is arranged in series or in parallel, while being spaced by a predetermined interval. Then, each of the battery units 20a, 20b, and 20c is interconnected by interconnecting the conductive coating layers 18 formed in each of the battery units through the bus bars 21a and 21b, thereby making it possible to complete the module.

Each of the battery units may be alternately interconnected in a zig-zag shape at both opposite sides thereof through the bus bars 21a and 21b. That is, as shown in FIG. 2, a first battery unit 20a and a second battery unit 20b may be interconnected through a first bus bar 21a on one side thereof, the second battery unit 20b and a third battery unit 20c may be interconnected through a second bus bar 21b on the other side thereof, and the third battery unit 20c and a fourth battery unit (not shown) may be interconnected through a third bus bar 21c on a side on which the first battery unit 20a and the second battery unit 20b are interconnected through the first bus bar 21a.

As described above, according to the exemplary embodiment of the present invention, the battery units are interconnected through the bus bar, which is a mechanical interconnection mechanism, thereby making it possible to more firmly form the module, as compared to the interconnection by the welding method according to the related art. Therefore, the devices suffering from much impact, vibration, etc., from the outside may satisfy a condition in which an electrical interconnection state and a physical coupling state between elements configuring the battery module should be stable, thereby making it possible to accomplish an important effect in view of stability of an energy storage for implementing high output and large capacity using the plurality of batteries.

In addition, the plurality of battery cells each formed by interconnecting the two unit batteries and seating the interconnected two unit batteries in the reception member are interconnected to manufacture the energy storage module, thereby making it possible to flexibly design the module according to the desired usage thereof.

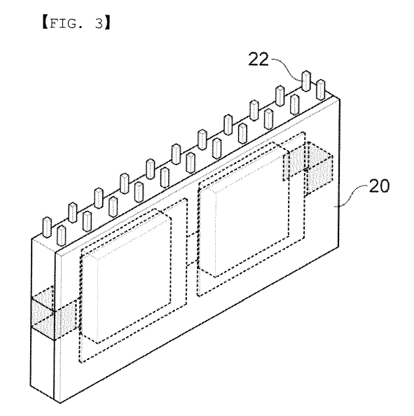

According to an exemplary embodiment of the present invention, as shown in FIG. 3, each of the battery units 20 may further include the heat radiating plate 22 such as the heat sink formed on the upper portion or the lower portion thereof. The heat radiating plate 22 is preferably made of a material having high thermal conductivity in order to effectively transfer the heat generated within the battery. In addition, the heat radiating plate 22 may also be formed in plural in each of the battery units 20. Considering that all of the energy storages generate the heat during charging and discharging thereof and may not exert their performances due to the deterioration caused by the heat, the energy storage module according to the exemplary embodiment of the present invention effectively solves the heat generation problem, thereby making it possible to improve the stability.

The energy storage according to the exemplary embodiment of the present invention may be used in a power tool; an electric vehicle including an electric vehicle (EV), a hybrid electric vehicle (HEV), and a plug-in hybrid electric vehicle (PHEV); an electric two-wheeled vehicle including an E-bike and an E-scooter; an electric golf cart, and the like, receiving electric power from an electric motor to be moved; however, a use range thereof is not limited thereto.

According to the exemplary embodiments of the present invention, a plurality of battery units in which two battery cells are previously seated in a reception member are interconnected to form the battery module, thereby making it possible to effectively form the module without allowing the battery cells to be in direct contact with each other.

In addition, the conductive coating layers are included in the upper and lower plates contacting the electrode tabs in the reception member to interconnect the conductive coating layers through the bus bar during manufacturing of the battery module rather than to interconnect the conductive coating layers by performing a welding method several times, thereby making it possible to more firmly couple the battery module.

According to the exemplary embodiments of the present invention, a plurality of battery cells each formed by interconnecting two battery cells are interconnected to manufacture the battery module, thereby making it possible to flexibly form the battery module, as needed, and effectively radiate the heat generated within the battery module during actual driving thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An energy storage module formed by interconnecting a plurality of battery units, each of the plurality of battery units being formed by interconnecting two unit batteries and seating the interconnected unit batteries in a reception member.

2. The energy storage module according to claim 1, wherein the reception member includes an upper plate and a lower plate, and the upper plate and the lower plate include conductive coating layers formed at parts contacting tabs of the battery unit.

3. The energy storage module according to claim 2, wherein the conductive coating layer is formed by plating a conductive metal.

4. The energy storage module according to claim 2, wherein the conductive coating layer is formed by compressing a conductive metal.

5. The energy storage module according to claim 1, wherein the reception member includes baskets for receiving electrode assemblies of the unit batteries therein.

6. The energy storage module according to claim 5, wherein the baskets are formed to have a height lower than those of cases of each of the unit batteries.

7. The energy storage module according to claim 1, wherein conductive coating layers formed at parts contacting tabs of the plurality of battery units are interconnected through a bus bar.

8. The energy storage module according to claim 1, wherein each of the battery units includes a cooling device.

9. The energy storage module according to claim 8, wherein the cooling device is included in an upper portion or a lower portion of each of the battery units.

10. A method for manufacturing an energy storage module, the method comprising:
interconnecting two unit batteries;
forming conductive coating layers at contacting parts of an upper plate and a lower plate of a reception member;
seating the interconnected unit batteries in the reception member to manufacture a battery unit;
interconnecting a plurality of battery units; and
interconnecting conductive coating layers formed at parts contacting tabs of the plurality of battery units through a bus bar.

11. The method according to claim 10, wherein the conductive coating layers are formed at the parts contacting the tabs of the battery units.

12. The method according to claim 10, further comprising attaching a cooling device to the battery unit.
